(19) United States
(12) Patent Application Publication
(10) Pub. No.: US 2007/0264897 A1
(43) Pub. Date: Nov. 15, 2007

(54) Polymeric webs with nanoparticles

(75) Inventors: Dimitris Ioannis Collias, Mason, OH (US); Norman Scott Broyles, Hamilton, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/434,371

(22) Filed: May 15, 2006

(51) Int. Cl. B32B 27/12; D04H 1/00; D02G 3/00; B32B 5/16

(52) U.S. Cl. 442/417; 428/401; 428/402; 442/394

(57) ABSTRACT

An expanded polymeric web includes between about 0.1 and about 70 weight percent of a compound comprising nanoparticles. The expanded polymeric web includes between about 30 and about 99.9 weight percent of a generally melt processable polymer. The web also includes between about 0.0 and about 50 weight percent of a compatibilizer. The expanded polymeric web comprises a first region and a second region, the first region undergoing a substantially molecular deformation and the second region initially undergoing a substantially geometric deformation when the polymeric web is subjected to an applied elongation along at least one axis, and wherein the expanded polymeric web has a greater propagation tear resistance than an expanded polymeric web of the melt processable polymer alone.

### FIELD OF THE INVENTION

The present invention relates to polymeric webs comprising nanoparticles. The invention relates particularly to expanded polymeric webs comprising nanoparticles.

### BACKGROUND OF THE INVENTION

Fillers (also called extenders) are used in the plastics industry (e.g. blow molded bottles, injection molded parts, blown or cast films, and fibers or non wovens) to “fill” the plastic parts. The purpose of the filler can be multifold. The filler can be used to replace plastic at lower cost thus improving the overall cost structure of the parts. The filler can also be used for performance related reasons such as stiffening, creating porosity, altering surface properties, etc. Typical examples of fillers are clays (natural and synthetic), calcium carbonate (CaCO₃), talc, silicate, glass microspheres (solid or hollow), ceramic microspheres, glass fibers, carbon-based materials (platelets, irregular, and fibril), etc.

To achieve their function, fillers need to be dispersed homogeneously in the polymer matrix and have optimal adhesion with the polymer matrix. These properties of homogeneous dispersion and optimal adhesion are achieved with good dispersive and distributive mixing and surface modification of the filler particles, such as coating of the surface of calcium carbonate fillers with stearic acid. Also, the surface modification alters the surface energy of some of the fillers, thus allowing optimal mixing with the polymer matrix. The typical size of the individual filler particle is on the order of μm or tens of μm, which results in <1 m²/g specific surface area available for interaction with the polymer matrix. This small specific surface area may explain the limited benefits typically seen with fillers.

Using a filler material having a greater surface area per gram of material may positively impact the performance to weight ratio of parts.

Expanded polymeric webs have great utility especially in the consumer products area. An important subsection of expanded polymeric webs is expanded polymeric webs which comprise a first region and a second region, the first region undergoing a substantially molecular deformation and the second region initially undergoing a substantially geometric deformation when the polymeric web is subjected to an applied elongation along at least one axis. These expanded polymeric webs find application in many areas such as elements of disposable products, particularly as elements of disposable bags and absorbent articles. The tear resistance property of the expanded polymeric webs can be quantified by propagation tear resistance measurement. A higher propagation tear resistance generally implies a stronger web that can be beneficial in many applications and/or allow for lightweighting of the expanded polymeric web via thickness reduction and/or better handling of the expanded polymeric web in the various manufacturing steps.

In general, the ability to maintain and/or improve the characteristics of the expanded polymeric web is desired.

### SUMMARY OF THE INVENTION

In one aspect, an expanded polymeric web consists of between about 0.1 and about 70 weight percent of a compound comprising nanoparticles, between about 30 and about 99.9 weight percent of a generally melt processable polymer, and between about 0.0 and about 50 weight percent of a compatibilizer. The expanded polymeric web comprises a first region and a second region, the first region undergoing a substantially molecular deformation and the second region initially undergoing a substantially geometric deformation when the polymeric web is subjected to an applied elongation along at least one axis. The propagation tear resistance of the expanded polymeric web is greater than the propagation tear resistance of an expanded polymeric web of the melt processable polymer alone.

In another aspect, a polymeric web consists of between about 0.1 and about 70 weight percent of a nanoclay, between about 30 and about 99.9 weight percent of a linear low density polyethylene (LLDPE), and between about 0.0 and about 50 weight percent of a compatibilizer. The web may be expanded such that it comprises a first region and a second region, the first region undergoing a substantially molecular deformation and the second region initially undergoing a substantially geometric deformation when the polymeric web is subjected to an applied elongation along at least one axis. The propagation tear resistance of the expanded polymeric web is greater than the propagation tear resistance of an expanded polymeric web of the linear low density polyethylene alone.

In yet another aspect, a base polymeric web consists of between about 0.1 and about 70 weight percent of a compound comprising nanoparticles, between about 30 and about 99.9 weight percent of a melt processable polymer, and between about 0.0 and 50 weight percent of a compatibilizer. The base polymeric web may be expanded by means known in the art. The expanded web comprising nanoparticles may have a greater propagation tear resistance than an expanded polymeric web of the melt processable polymer alone.

### DETAILED DESCRIPTION OF THE INVENTION

Unless stated otherwise, all weight percentages are based upon the weight of the polymeric web as a whole. All exemplary listings of web constituents are understood to be non-limiting with regard to the scope of the invention.

I. Definitions

As used herein, the term “expanded polymeric web” and its derivatives refer to a polymeric web formed from a precursor polymeric web or film (equivalently called “base polymeric web” or “base polymeric film” herein), e.g. a planar web, that has been caused to conform to the surface of a three dimensional forming structure so that both sides or surfaces of the precursor polymeric web are permanently altered due to at least partial conformance of the precursor polymeric web to the three-dimensional pattern of the forming structure. In one embodiment the expanded polymeric web is a three dimensional web that comprises macroscopic and/or microscopic structural features or elements. Such expanded polymeric webs may be formed by embossing (i.e., when the forming structure exhibits a pattern comprised primarily of male projections) or debossing (i.e., when the forming structure exhibits a pattern comprised primarily of female depressions or apertures), by tentering, or by a combination of these. The expanded polymeric web may comprise a first region and a second region, the first region may undergo a substantially molecular deformation and the second region may initially undergo a substantially geometric deformation when the polymeric web is subjected to an applied elongation along at least one axis.

As used herein, the term “macroscopic” and its derivatives refer to structural features or elements that are readily visible and distinctly discernable to a human having a 20/20 vision when the perpendicular distance between the viewer's eye and the web is about 12 inches.

As used herein, the term “microscopic” and its derivatives refer to structural features or elements that are not readily visible and distinctly discernable to a human having a 20/20 vision when the perpendicular distance between the viewer's eye and the web is about 12 inches.

As used herein, the term “propagation tear resistance” and its derivatives refer to the machine direction and/or cross machine direction propagation tear resistance measured according to the ASTM D 1922-05 Standard Test Method for Propagation Tear Resistance of Plastic Film and Thin Sheeting by Pendulum Method.

II. Expanded Polymeric Webs

In one embodiment, an expanded polymeric web comprises between about 0.1 and about 70 weight percent of a compound comprising nanoparticles. Nanoparticles are discrete particles comprising at least one dimension in the nanometer range. Nanoparticles can be of various shapes, such as spherical, fibrous, polyhedral, platelet, regular, irregular, etc. In another embodiment, the lower limit on the percentage by weight of the compound may be about 1 percent. In still another embodiment, the lower limit may be about 2 percent. In yet another embodiment, the lower limit may be about 3 percent. In still yet another embodiment, the lower limit may be about 4 percent. In another embodiment, the upper limit may be about 50 percent. In yet another embodiment, the upper limit may be about 30 percent. In still another embodiment, the upper limit may be about 25 percent. The amount of the compound present in the polymeric web may be varied depending on the target product cost and expanded polymeric web properties. Non-limiting examples of nanoparticles are natural nanoclays (such as kaolin, talc, bentonite, hectorite, nontmorillonite, vermiculite, and mica), synthetic nanoclays (such as Laponite® from Southern Clay Products, Inc. of Gonzales, TX; and SOMASIF from CO-OP Chemical Company of Japan), treated nanoclays (such as organically-treated nanoclays), nanofibers, metal nanoparticles (e.g. nano aluminum), metal oxide nanoparticles (e.g. nano alumina), metal salt nanoparticles (e.g. nano calcium carbonate), carbon or inorganic nanostructures (e.g. single wall or multi wall carbon nanotubes, carbon nanorods, carbon nanoribbons, carbon nanorings, carbon or metal or metal oxide nanofibers, etc.), and graphite platelets (e.g. expanded graphite, etc.).

In one embodiment, the compound comprising nanoparticles comprises a nanoclay material that has been exfoliated by the addition of ethylene vinyl alcohol (EVOH) to the material. As a non-limiting example, a nanoclay montmorillonite material may be blended with EVOH (27 mole percent ethylene grade). The combination may then be blended with an LLDPE polymer and the resulting combination may be blown or cast into films. The combination of LLDPE, EVOH and nanoclay materials has been found to possess a substantially higher tensile modulus than the base LLDPE, and substantially similar tensile toughness as LLDPE.

The compound comprising nanoparticles may comprise nanoclay particles. These particles consist of platelets that may have a fundamental thickness of about 1 nm and a length or width of between about 100 nm and about 500 nm. In their natural state these platelets are about 1 to about 2 nm apart. In an intercalated state, the platelets may be between about 2 and about 8 nm apart. In an exfoliated state, the platelets may be in excess of about 8 nm apart. In the exfoliated state the specific surface area of the nanoclay material can be about 800 m²/g or higher. Exemplary nanoclay materials include montmorillonite nanoclay materials and organically-treated montmorillonite nanoclay materials (i.e., montmorillonite nanoclay materials that have been treated with a cationic material that imparts hydrophobicity and causes intercalation), and equivalent nanoclays as are known in the art. Such materials are available from Southern Clay Products, Inc. of Gonzales, Tex. (e.g. Cloisite® series of nanoclays); Elementis Specialties, Inc. of Hightstown, N.J. (e.g. Bentone® series of nanoclays); Nanocor, Inc. of Arlington Heights, Ill. (e.g. Nanomer® series of nanoclays); and Süd-Chemie, Inc. of Louisville, Ky. (e.g. Nanofil® series of nanoclays).

The expanded polymeric web also comprises between about 30 and about 99.9 percent of a melt processable polymer. The melt processable polymer may consist of any such melt processable thermoplastic material or their blends. Exemplary melt processable polymers include low density polyethylene, such as ExxonMobil LD129.24 low density polyethylene available from the ExxonMobil Company, of Irving, Texas; linear low density polyethylene, such as Dowlex™ 2045A and Dowlex™ 2035 available from the Dow Chemical Company, of Midland, Michigan; and other thermoplastic polymers as are known in the art (e.g. high density polyethylene-HDPE; polypropylene-PP; very low density polyethylene-VLDPE; ethylene vinyl acetate-EVA; ethylene methyl acrylate-EMA; EVOH, etc). Furthermore, the melt processable thermoplastic material may comprise typical additives (such as antioxidants, antistatics, nucleators, conductive fillers, flame retardants, pigments, plasticizers, impact modifiers, etc.) as are known in the art. The weight percentage of the melt processable polymer present in the polymeric web will vary depending upon the amount of the compound comprising nanoparticles and other web constituents present in the polymeric web.

The expanded polymeric web may further comprise a compatibilizer in the range from about 0 to about 50 percent by weight. The compatibilizer may provide an enhanced level of interaction between the nanoparticles and the polymer molecules. Exemplary compatibilizers include maleic anhydride, and maleic-anhydride-modified polyolefin as these are known in the art (e.g. maleic-anhydride-grafted polyolefin).

The nanoclay (typically organically-treated nanoclay) and compatibilizer may be provided as a masterbatch that may be added to the polymeric web as a single component. Exemplary examples include the NanoBlend™ materials supplied by PolyOne Corp. of Avon Lake, Ohio, and Nanofil® materials supplied by Süd-Chemie, Inc. of Lousville, Ky.

The precursor polymeric web may be formed using any method known in the art, including, without limitations, casting or blowing the polymeric web. Also, the precursor polymeric web may comprise a single layer or multiple layers.

In one embodiment, the base polymeric web may be processed to become expanded. In this embodiment, the base polymeric web may be pressed between a set of intermeshing plates. The plates may have intermeshing teeth and may be brought together under pressure to deform a portion of the polymeric web.One plate may include toothed regions and grooved regions. Within the toothed regions of the plate there may be a plurality of teeth. The other plate may include teeth which mesh with teeth of the first plate. When a polymeric web is formed between the two plates the portions of the film which are positioned within grooved regions of the first plate and teeth of the second remain undeformed. The portions of the web positioned between toothed regions of the first plate and the teeth of the second plate are incrementally and plastically formed creating rib-like elements in the polymeric web.

The method of formation can be accomplished in a static mode, where one discrete portion of a web is deformed at a time. Alternatively, the method of formation can be accomplished using a continuous, dynamic press for intermittently contacting the moving web and forming the base material into a formed polymeric web of the present invention. These and other suitable methods for forming the polymeric web of the present invention are more fully described in U.S. Pat. No. 5,518,801 issued to Chappell, et al. on May 21, 1996. Polymeric webs formed in this manner may be described in U.S. Pat. No. 5,650,214 issued to Anderson, et al. on Jul. 22, 1997.

Such an expanded polymeric web may comprise a first region and a second region. When the polymeric web is subjected to an applied elongation along at least one axis the first region may undergo a substantially molecular deformation and the second region may initially undergo a substantially geometric deformation. The expanded polymeric web with nanoparticles has greater propagation tear resistance than a similarly expanded polymeric web without nanoparticles.

Other materials, such as fillers, may be added to the precursor polymeric web. In one embodiment, the precursor polymeric web may comprise calcium carbonate (CaCO₃) in an amount of between about 5% and about 70% of CaCO₃. When the precursor polymeric web that comprises fillers is expanded according to the present invention to comprise a first region and a second region, the second region may be macroscopic, i.e., readily visible and distinctly discemable to a human having a 20/20 vision when the perpendicular distance between the viewer's eye and the expanded polymeric web is about 12 inches.

In one embodiment of the present invention, the difference between the propagation tear resistances of an expanded polymeric web comprising nanoparticles and a similarly expanded polymeric web with the same composition but without nanoparticles is greater than the difference between the propagation tear resistances of the precursor polymeric web comprising nanoparticles and a similar precursor polymeric web with the same composition but without nanoparticles.

### EXAMPLE 1

A 1 mil (0.0254 mm) thick cast film of linear low density polyethylene is prepared together with a 1 mil (0.0254 mm) thick cast film of the same polymer together with 10% by weight of NanoBlend™ 2101 which comprises between 38% and 42% organically-treated montmorillonite nanoclay particles. Each of the cast films is expanded yielding an expanded film with first regions and second regions, with the first regions undergoing a substantially molecular deformation and the second regions initially undergoing a substantially geometric deformation when the polymeric web is subjected to an applied elongation along at least one axis. The propagation tear resistance of each expanded polymeric web is tested and the nanocomposite film is found to have a machine direction propagation tear resistance about 70% higher than that of the expanded polymeric web comprising no nanoclay particles.

### EXAMPLE 2

A 1 mil (0.0254 mm) thick cast film of linear low density polyethylene is prepared together with a 1 mil (0.0254 mm) thick cast film of the same polymer together with 10% by weight of NanoBlendυ 2101 which comprises between 38% and 42% organically-treated montmorillonite nanoclay particles, and 20% by weight CaCO₃ particles. Each of the cast films is expanded yielding an expanded film with first regions and second regions, with the first regions undergoing a substantially molecular deformation and the second regions initially undergoing a substantially geometric deformation when the polymeric web is subjected to an applied elongation along at least one axis. The propagation tear resistance of each expanded polymeric web is tested and the nanocomposite film is found to have a machine direction propagation tear resistance about 70% higher than that of the expanded polymeric web comprising no nanoclay particles. Furthermore, the expanded polymeric web comprising the nanoclay particles and CaCO₃ has macroscopic second regions, i.e., second regions that are readily visible and distinctly discemable to a human having a 20/20 vision when the perpendicular distance between the viewer's eye and the expanded polymeric web is about 12 inches.

### PRODUCT EXAMPLES

The expanded polymeric web materials of the invention may be utilized in any application where an expanded web or an elastic-like web would be beneficial. The requirements of the intended use may be associated with the particular composition of the web.

Web materials having first and second regions with different response to applied stress may be utilized in applications where some degree of elasticity, web drape, or both are desired. Exemplary uses include, without being limiting, diaper leg cuffs and side panels, training pant panels, feminine hygiene product edge portions, and adult incontinence panels.

In one embodiment, an absorbent article may comprise an expanded polymeric film having first regions and second regions as set forth above. Such films may be used as a portion of absorbent articles including without being limiting, diapers, feminine hygiene garments, adult incontinences articles, training pants, and diaper holders. Such films may be used to impart an elastic-like nature to at least a portion of an article.

The expanded polymeric web materials described may be utilized as elements of other products as well as the uses set forth above. Exemplary uses for the expanded polymeric webs include, without limiting the invention, film wraps, bags, polymeric sheeting, outer product coverings, packaging materials, and combinations thereof.

The expanded polymeric web materials may be incorporated into products as direct replacements for otherwise similar web materials which do not comprise nanoparticles.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would have been obvious to those skilled in the art that various other changes and modifications can be made without departing from the spirit and scope of the invention. It is therefore intended to cover in the appended claims all such changes and modifications that are within the scope of the invention.

What is claimed is:

1. An expanded polymeric web comprising:
a) between about 0.1 and about 70 weight percent, of a compound comprising nanoparticles,
b) between about 30 and about 99.9 weight percent of a generally melt processable polymer, and
c) between about 0.0 and about 50 weight percent of a compatibilizer,
wherein the expanded polymeric web comprises a first region and a second region, the first region undergoing a substantially molecular deformation and the second region initially undergoing a substantially geometric deformation when the polymeric web is subjected to an applied elongation along at least one axis, and wherein the expanded polymeric web has a greater propagation tear resistance than an expanded polymeric web of the melt processable polymer alone.

2. The polymeric web according to claim 1 wherein the base polymeric web is a cast film.

3. The polymeric web according to claim 1 wherein the base polymeric web is a blown film.

4. The polymeric web according to claim 1 wherein the generally melt processable polymer comprises a linear low density polyethylene.

5. The polymeric web according to claim 4 wherein the linear low density polyethylene material comprises a low density polyethylene.

6. The polymeric web according to claim 1 wherein the nanoparticles comprise a nanoclay material.

7. The polymeric web according to claim 6 wherein the nanoclay material comprises organically-treated montmorillonite nanoclay material.

8. The polymeric web according to claim 7 comprising between about 5 and about 70 weight percent of calcium carbonate.

9. The polymeric web according to claim 8 wherein the second region is macroscopic.

10. An expanded polymeric web comprising:
a) between about 0.1 and about 70 weight percent of a nanoclay,
b) between about 30 and about 99.9 weight percent of a linear low density polyethylene, and
c) between about 0.0 and about 50 weight percent of a compatibilizer,
wherein the expanded polymeric web comprises a first region and a second region, the first region undergoing a substantially molecular deformation and the second region initially undergoing a substantially geometric deformation when the base polymeric web is subjected to an applied elongation along at least one axis, and wherein the expanded polymeric web has a greater propagation tear resistance than an expanded polymeric web of the low density polyethylene alone.

11. The polymeric web according to claim 10 wherein the base polymeric web is a cast film.

12. The polymeric web of claim 10 wherein the base polymeric web is a blown film.

13. The polymeric web according to claim 10 wherein the linear low density polyethylene material comprises a low density polyethylene.

14. The polymeric web according to claim 10 comprising between about 5 and about 70 weight percent of calcium carbonate.

15. The polymeric web according to claim 14 wherein the second region is macroscopic.

16. A disposable absorbent product comprising an expanded polymeric web, the expanded polymeric web comprising:
a) between about 0.1 and about 70 weight percent, of a compound comprising nanoparticles,
b) between about 30 and about 99.9 weight percent of a generally melt processable polymer, and
c) between about 0.0 and about 50 weight percent of a compatibilizer,
wherein the expanded polymeric web comprises a first region and a second region, the first region undergoing a substantially molecular deformation and the second region initially undergoing a substantially geometric deformation when the polymeric web is subjected to an applied elongation along at least one axis, and wherein the expanded polymeric web has a greater propagation tear resistance than an expanded polymeric web of the melt processable polymer alone.

17. The disposable absorbent product according to claim 16 further comprising between about 5 weight percent and 70 weight percent of calcium carbonate.

18. A disposable bag product comprising an expanded polymeric web, the expanded polymeric web comprising:
a) between about 0.1 and about 70 weight percent, of a compound comprising nanoparticles,
b) between about 30 and about 99.9 weight percent of a generally melt processable polymer, and
c) between about 0.0 and about 50 weight percent of a compatibilizer,
wherein the expanded polymeric web comprises a first region and a second region, the first region undergoing a substantially molecular deformation and the second region initially undergoing a substantially geometric deformation when the polymeric web is subjected to an applied elongation along at least one axis, and wherein the expanded polymeric web has a greater propagation tear resistance than an expanded polymeric web of the melt processable polymer alone.

19. The disposable bag product according to claim 18 further comprising between about 5 weight percent and 70 weight percent of calcium carbonate.
